(19) United States
(12) Patent Application Publication
(10) Pub. No.: US 2023/0164114 A1
(43) Pub. Date: May 25, 2023

(54) SYSTEM AND METHOD FOR MANAGING AND SECURING AN ENTERPRISE NETWORK ASSOCIATED WITH AN ORGANIZATION

(71) Applicant: Pratexo, Inc., Austin, TX (US)

(72) Inventor: Petter Graff, Austin, TX (US)

(21) Appl. No.: 18/056,308

(22) Filed: Nov. 17, 2022

Related U.S. Application Data
(60) Provisional application No. 63/281,093, filed on Nov. 19, 2021.

(51) Int. Cl. H04L 9/40

(52) U.S. Cl. CPC H04L 63/0209; H04L 63/105

(57) ABSTRACT

A system and method for managing and securing an enterprise network associated with an organization is disclosed. The method includes segmenting an enterprise network into a set of security zones, establishing a communication path between an external zone and an external network card for allowing the external zone to access external networks, and establishing a communication path between the internal zone and an internal network card for allowing the internal zone to access the enterprise network. Furthermore, the method includes performing a partitioning operation on a hardware solution to divide the hardware partition into one or more hardware units, allocating the one or more hardware units to the set of security zones, and assigning one or more access rights to the external zone. The method includes assigning one or more internal services to the internal zone and performing one or more first gateway operations.

### EARLIEST PRIORITY DATE

This Application claims priority from a provisional patent application filed in the US having Patent Application No. 63,281,093, filed on Nov. 19, 2021 and titled “SYSTEM AND METHOD FOR SECURE EDGE MANAGER”.

### FIELD OF INVENTION

Embodiments of the present disclosure relate to edge computing systems, and more particularly relates to a system and method for managing and securing an enterprise network associated with an organization.

### BACKGROUND

Typically, during installation of an edge solution, an installer faces a plurality of problems. The installer is a logical module responsible for ensuring that a set of computers also termed as edge nodes are configured correctly according to the rules for a particular solution. Often, the computers come with a minimal installation from the manufacturer with an operating system that allows the machine to connect to a solution. When the machine comes up the first time, the installer ensures that the software on the machine is replaced (or augmented) with the solution-specific software. The installer is also responsible for updating the software on the computers when that is required (e.g., a security vulnerability requires a change to the software or new requirements require updated solutions). For example, there is a problem in network configuration. Under the problem of network configuration, a network cannot be exposed to external networks for security or legislative reasons. The legislative reasons are generally different to every country, for example in Norway, the computers involved with monitoring or controlling the power grid are not allowed to be connected to the internet. Further, the network may not be configured in ways to support the installation of edge nodes. For example, a Domain Name System (DNS) service may not be working properly, ports required by the installation may be blocked and the like. Furthermore, the plurality of problems include a bootstrapping problem. Under the problem of bootstrapping, multiple compute clusters require some form of bootstrapping. For example, in PxE boot, the presence of a PxE boot manager and a PxE boot storage service is necessary, in Kubernetes, an existing edge node is required in the cluster of edge nodes to issue keys for new edge nodes that join the cluster of edge nodes. During general configuration, when the new edge node joins the cluster of edge nodes, there may be a unique configuration to the role played by the edge node in the cluster of edge nodes which is required to be sent to the new edge node. This unique configuration may be based on history of the location (for example, in some cases, if the new edge node is replacement for the edge node which used to play a role, then the new edge node may restore the state of the replaced edge node). The unique configuration may also be based on central configuration system including the configuration for individual edge nodes. Furthermore, the plurality of problems includes a problem in distribution of software and software updates. Under the problem of the distribution of the software and the software updates, most of software distribution methods require access to external repository. The external repository may not be available to a local network. Further, update packages may require multiple independent verification of authenticity for security reasons. Furthermore, the plurality of problems include a problem in rolling installation of the cluster solutions. Under this problem of rolling installation of the cluster solutions, most of the cluster solutions assume that all the edge nodes are available at the time of the installation. This is applicable in a data center with fixed or semi-fixed compute resources. In the edge solution, the edge nodes are installed gradually over time, and it is not possible to install the edge nodes incrementally. Further, when installing the cluster for any solution, a set of challenges may be faced, such as the rolling installations, the client may have internet access and challenging network configurations. For example, under the rolling installations, the customer may put together the initial cluster, but then add nodes to the cluster slowly over time. Further, most Linux based installations require intern& access. Thus, it is required to provide either offline registries or images where the tools coming from external sources are preinstalled. Further, it is very difficult to dictate the customer's network configuration. Furthermore, multiple networks are configured in ways that make installation challenging, such as daisy-chains, multiple Dynamic Host Configuration Protocol (DHCP) servers, and the like.

Further, the plurality of problems include a problem associated with complexity of installation. Typically, the edge node combines several technologies. One of the existing technologies is repositories of software modules. These repositories of software modules are docker images, helm charts for Kubernetes, maven artifacts for java modules, Performance Improvement Plan (PIP) repositories for python programs, Node Package Manager (NPM) repositories for NodeJS programs, Automatic Package Transfer (APT) repositories for Linux distributions and the like. Another existing technology include PxE boot management which consoles to manage PxE boot configurations, running of installation scripts, such as Ansible, Terraform, Chef or Puppet, over the air firmware installations and the like. Over the air firmware installations include propriety solutions from various vendors. Another existing technology include distribution of machine learning models, the distribution of rules to various dynamic rule systems such as Jrules, Node-Red, the distribution of complex applications to achieve business specific goals, and the like. All the existing technologies require special skills, such as training of local personnel particularly in disconnected environments. Further, another challenge with the existing technology is partial ordering requirements which may further increase the complexity. For example, first PxE boot distribution is run, then an Ansible script is run to update the edge nodes and then over-the air firmware upgrade is run. Further, the plurality of problems include a problem associated support for complex installation scenarios. In this problem, the first challenge is in alpha or beta testing. In the alpha or the beta testing, customers may want to run two configurations simultaneously to compare performance or corrections of new versions. Further, in this problem, the second challenge is in rolling installation. In the rolling installation for example, first a software is installed on ten percent of the edge nodes and then after half an hour the software is installed on thirty percent of the edge nodes and so on. Furthermore, in this problem, the third challenge is in rollback. In the rollback, if the installation is failing, the installation cannot be started again, and the edge nodes cannot be restored again to the previous state.

Hence, there is a need for an improved system and method for managing and securing an enterprise network associated with an organization, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a computing system for managing and securing an enterprise network associated with an organization is disclosed. The computing system includes one or more hardware processors and a memory coupled to the one or more hardware processors. The memory includes a plurality of modules in the form of programmable instructions executable by the one or more hardware processors. The plurality of modules include a network segmenting module configured to segment an enterprise network associated with an organization into a set of security zones. The set of security zones include an external zone, a gateway zone and an internal zone. The gateway zone bridges the internal zone and the external zone. The plurality of modules also include a communication module configured to establish a communication path between the external zone and an external network card for allowing the external zone to access a set of external networks. Further, the communication module is configured to establish a communication path between the internal zone and an internal network card for allowing the internal zone to access the enterprise network upon establishing the communication path between the external zone and the external network card. The plurality of modules also include a hardware partition module configured to perform a partitioning operation on a hardware solution to divide the hardware partition into one or more hardware units upon establishing the communication path between the internal zone and the internal network card. The hardware solution corresponds to a hard disk. The one or more hardware units includes an external hardware unit, a gateway hardware unit and an internal hardware unit. Furthermore, the plurality of modules also include a hardware allocation module configured to allocate the one or more hardware units to the set of security zones. The external hardware unit is allocated to the external zone. The gateway hardware unit is allocated to the gateway zone. The internal hardware unit is allocated to the internal zone. The plurality of modules include a data assignment module configured to assign one or more access rights to the external zone for providing limited access of the allocated external hardware unit. Further, the data assignment module is configured to assign one or more internal services to the internal zone for performing one or more internal operations by using the allocated internal hardware unit upon assigning the one or more access rights to the external zone. The one or more internal services include install script runners, installation tools, PxE boot server, PxE boot image service, docker, workflow managers, offline repositories and data collection services. The plurality of modules an operation performing module configured to perform one or more first gateway operations via the gateway zone by using the allocated gateway hardware unit upon assigning the one or more internal services to the internal zone. The one or more first gateway operations include verification of certificates, verification of correctness of incoming and outgoing data, and copying of data from the internal zone to the external zone.

In accordance with another embodiment of the present disclosure, a method for managing and securing an enterprise network associated with an organization is disclosed. The method includes segmenting an enterprise network associated with an organization into a set of security zones. The set of security zones comprise an external zone, a gateway zone and an internal zone. The gateway zone bridges the internal zone and the external zone. The method further includes establishing a communication path between the external zone and an external network card for allowing the external zone to access a set of external networks. Further, the method includes establishing a communication path between the internal zone and an internal network card for allowing the internal zone to access the enterprise network upon establishing the communication path between the external zone and the external network card. Furthermore, the method includes performing a partitioning operation on a hardware solution to divide the hardware partition into one or more hardware units upon establishing the communication path between the internal zone and the internal network card. The hardware solution corresponds to a hard disk. The one or more hardware units comprise an external hardware unit, a gateway hardware unit and an internal hardware unit. Further, the method includes allocating the one or more hardware units to the set of security zones. The external hardware unit is allocated to the external zone. The gateway hardware unit is allocated to the gateway zone. The internal hardware unit is allocated to the internal zone. The method includes assigning one or more access rights to the external zone for providing limited access of the allocated external hardware unit. The method includes assigning one or more internal services to the internal zone for performing one or more internal operations by using the allocated internal hardware unit upon assigning the one or more access rights to the external zone. The one or more internal services include install script runners, installation tools, PxE boot server, PxE boot image service, docker, workflow managers, offline repositories and data collection services. The method includes performing one or more first gateway operations via the gateway zone by using the allocated gateway hardware unit upon assigning the one or more internal services to the internal zone. The one or more first gateway operations include verification of certificates, verification of correctness of incoming and outgoing data, and copying of data from the internal zone to the external zone.

Embodiment of the present disclosure also provide a non-transitory computer-readable storage medium having instructions stored therein that, when executed by a hardware processor, cause the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating an exemplary computing system implementing of multiple security zones, in accordance with an embodiment of the present disclosure;

FIG. 2 is an exemplary edge computing environment capable of managing one or more edge nodes by using the computing system, in accordance with an embodiment of the present disclosure;

FIG. 3 is a block diagram illustrating an exemplary computing system for managing and securing an enterprise network associated with an organization, in accordance with an embodiment of the present disclosure; and

FIG. 4 is a process flow diagram illustrating an exemplary method for managing and securing the enterprise network associated with an organization, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

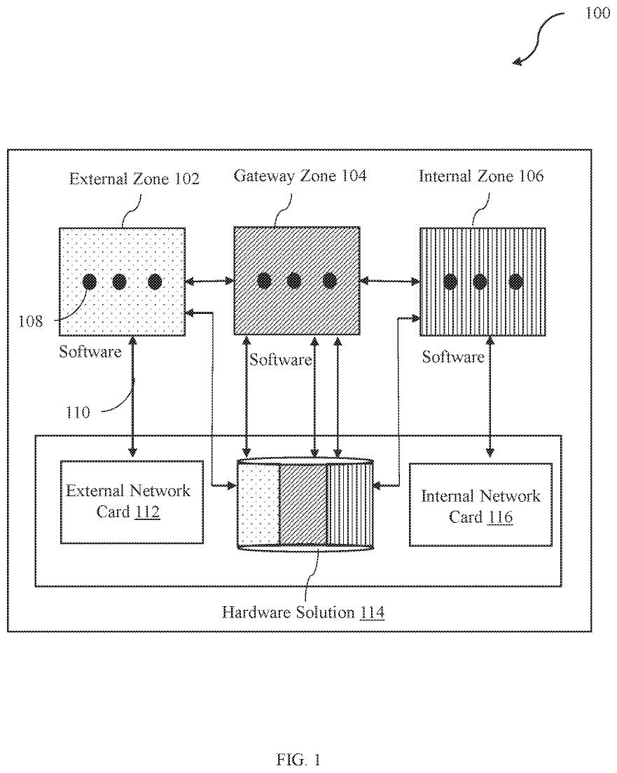

Referring now to the drawings, and more particularly to FIGS. 1 through FIG. 4, where similar reference characters denote corresponding features consistently throughout the figures, there are shown preferred embodiments and these embodiments are described in the context of the following exemplary system and/or method.

FIG. 1 is a block diagram illustrating an exemplary computing system 100 implementing of multiple security zones, in accordance with an embodiment of the present disclosure. In an embodiment of the present disclosure, the computing system 100 segments an enterprise network associated with an organization into a set of security zones. The network segmentation strategy used in the present invention is both logical and physical. Physically, the present invention operates with at least two different network cards that form a physical segmentation of the network. Further, the present invention logically through software ensures that each software component only can access one of the network cards. Restricting the software component from bridging the two networks. In an exemplary embodiment of the present disclosure, the set of security zones include an external zone 102, a gateway zone 104 and an internal zone 106. The enterprise network includes physical and virtual networks, and protocols that connect all users and systems on a Local Area Network (LAN) to applications in a data center and cloud as well as facilitates access to network data and analytics. In an embodiment of the present disclosure, the computing system 100 corresponds to a central server, such as a cloud server or a remote server. Further, each of the set of security zones includes one or more services 108 deployed on the set of security zones. The one or more services that run in the external zone are: Docker container puller that pulls docker containers from controlled repositories, Helmchart puller that pulls Kubernetes helm charts from controlled repositories, Data uploader that provides a secure connection to data lakes running external to the solution for the purpose of uploading data. Examples of the one or more services that run in the internal zone are: PxE boot server for use of PxE boot to install software on new computers, Ansible installer for use to update or patch software on existing computers, a data subscriber that fetches data from nodes to be shared with the external zone. In an embodiment of the present disclosure, a set of access paths 110 state that access of only one or more applications can be granted (only explicit grant) to the set of security zones, such as an external network card 112, a hardware solution 114 and an internal network card 116, as shown in FIG. 1. In an embodiment of the present disclosure, the hardware solution 114 corresponds to a hard disk.

In an embodiment of the present disclosure, when all services are deployed on a single machine i.e., a hard disk, the single machine may have explicit partitions where the set of security zones are granted with limited access. In the external zone 102, a software has direct access to external networks. In an embodiment of the present disclosure the software corresponds to applications or daemons. For example, the present invention can possibly possess an application that is started every 24 hours to upload data to some external site. An example of a daemon is a process that runs at every time instance with respect to the incoming requests. Further, in the external zone 102, the software has limited access to the hardware solution 114. The limited access are rule based such as, reading a specific directory directly in a file system, access to the external network card 112 and not to the internal network card 116, access to specific external sites or ports, limited access to specific external protocols, write access to a specific directory and no access to reading or deleting the specific directory and the like. A file system corresponds to the manner in which files are named, stored, and retrieved from a storage device. Further, a specific directory refers to a named folder or a location in the file system. The named folder can have any number of files and sub-folders. The present invention controls the access to the named folder utilizing the operating systems access control. Furthermore, the internal network card, corresponds to a network connection that is not exposed to the external world in most cases, the internet. Thereby enabling access to the internal process without accessing the internet. The protocols used are MQTT and AMQP. Wherein, Message Queuing Telemetry Transport (MQTT) is a lightweight, publish-subscribe, machine to machine network protocol for Message queue/Message queuing service. Further the Advanced Message Queuing Protocol (AMQP) is an open standard application layer protocol for message-oriented middleware. The defining features of AMQP are message orientation, queuing, routing: including point-to-point and publish-and-subscribe, reliability and security. In the internal zone 106, the software has access to internal networks. Further, in the internal zone 106, the software includes various services, such as installation of script runners, PxE boot server, PxE boot image service, data collection services and the like. Wherein, the script runner is a software application that can parse and interpret a text file that further gets converted into a set of operations on the machine. A common name is an interpreter. The abbreviation of PxE boot is Preboot eXecution Environment. When using the PXE, one requires a PxE boot server. The PXE Boot server installs images often known as PxE boot images. When a machine starts, the machine checks with the PxE boot server to see which “image” (software) should be on the machine. If there is a new image, the old image is removed, the new image is downloaded and the machine reboots. If there exist no new images, the machine continues a regular boot sequence. Further, In the present invention data collection services are used to interchange data between the different security zones, example, the present invention has an application that fetches data from machines running in the internal network to make it available to the software running with access to the external network. The gateway zone 104 bridges the internal zone 106 and the external zone 102. The services in the gateway zone 104 do not have direct access to either the external network card 112 or the internal network card 116. However, the gateway zone 104 provides the services, such as verification of certificates, verification of correctness of incoming data and outgoing data, and copying of data from the internal zone 106 to the external zone 102. This creates software solution and the hardware solution 114 which makes installation technologies a single cohesive solution. In an exemplary embodiment of the present disclosure, the present invention aims to provide a solution for potential customers. For example, the present method installs a software for a power company in order to collect data from sensors positioned at substations, interpret the data, and provide recommendations regarding optimization operations of the power company. Wherein, each solution requires some hardware to be installed such as, the present method may have to install a computer in each substation, install some sensors to measure the operation of the substation, wire the substation together and the like. Subsequent to the installation of the hardware, the present method installs the software on the various computers. The software consists of various components including applications, daemons, libraries, tools and the like. The components collaborate to solve the customers problem. The present invention uses the term software solution to describe the collection of software's that makes up for similar kind of solutions. The software solution may be able to run in a cloud environment with few network configurations. The software solution is preferred wherever it is possible to run in the cloud environment however, for developers and for challenging network environments the hardware solution 114 is required.

Further, a possible deployment is to have a single computer with implementation of all the multiple security zones. In an embodiment of the present disclosure, the single computer includes two network cards. Further, one network connection is explicitly marked to be used for the external zone 102. The other network connection is explicitly marked to be used for the internal zone 106. In an embodiment of the present disclosure, the network connection may be either of the two network cards. Further, a boot software controls the launch of every program and ensures necessary permissions are enforced. The boot software first launches software for the gateway zone 104. The gateway zone 104 includes a set of agents which monitor access, verify integrity of firmware, memory, and storage prior to permitting the services to run in other multiple security zones. Furthermore, the boot software starts the services in the internal zone 106 with one or more first permissions. The one or more first permissions may vary with each internal service. In an exemplary embodiment of the present disclosure, the one or more first permissions include access to specific partitions or directories of the local storage such as read or write permissions, permission to open specific ports on the internal network card 116, permission to access specific ports opened in the gateway zone 104. The boot software starts up the external zone 102. As compared with the internal zone 106, one or more second permissions for the software running in the external zone 102 is limited to essential resources. In an exemplary embodiment of the present disclosure, the one or more second permissions for running software in the external zone 102, such as ability to open server ports on the external network card 112, permission to read and or write to specific partitions on internal storage and permission to access specific ports opened in the gateway zone 104. In an embodiment of the present disclosure, the prohibition logic is implemented in the gateway zone 104 to manage services of each of the internal zone 106 and the external zone 102. In an exemplary embodiment of the present disclosure, the prohibition logic includes one or more modules running in the internal zone 106 and the external zone 102 are not allowed to access same partitions or directories, the one or more modules running in the internal zone 106 are not allowed to access the external network and the one or more modules running in the external zone 102 are not allowed to access the enterprise network. Examples of the one or more modules running in the internal zone are: Kibana, Grafana, Mosquitto, Node-Red and the like.

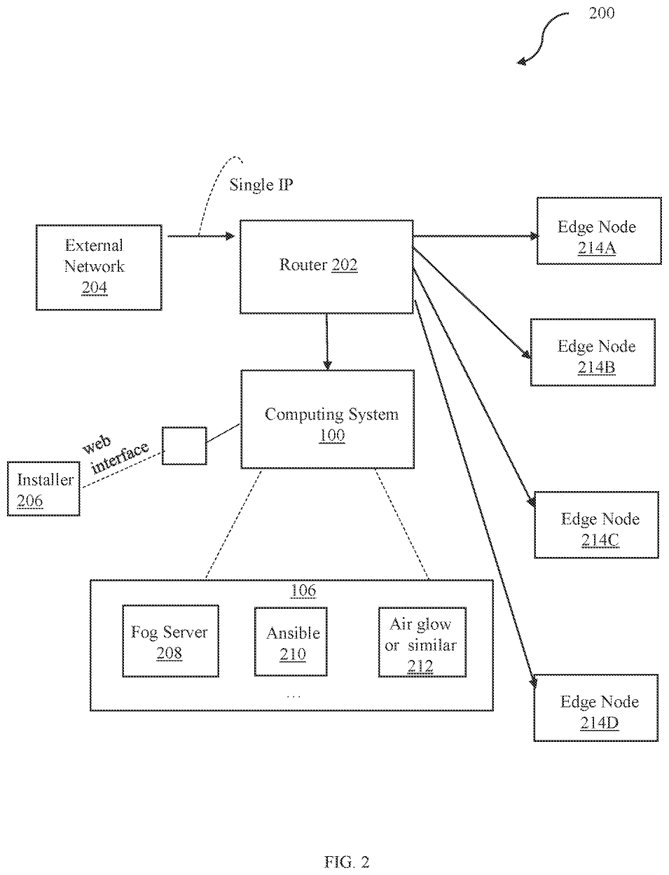

FIG. 2 is an exemplary edge computing environment 200 capable of managing one or more edge nodes by using the computing system 100, in accordance with an embodiment of the present disclosure. The computing system 100 is configured to control a set of settings. In an exemplary embodiment of the present disclosure the set of settings include number of replicas of data files, configuration of what parameters to read from a ModBus protocol, IP addresses of connected devices and the like. In an embodiment of the present disclosure, a router 202 connects to an external network 204 and has a single Internet Protocol (IP) address. In an embodiment of the present disclosure, the computing system 100 is communicatively coupled to an installer 206. With respect to the external network 204, all system components are considered as a single device. All internal networks are isolated, and the computing system 100 has full control. The computing system 100 has all the required software installed when the installation machine boots up. In an embodiment, the workflow of the computing system 100 includes the hardware solution 114. The router 202 is preconfigured to be optimal for edge installation scenarios. For example, definition of their own Dynamic Host Configuration Protocol (DHCP), a predictable subnet setup and the like. In an embodiment of the present disclosure, the router 202 is a standard router having full control of settings. Further, the internal zone 106 includes a set of software components, such as fog server 208, ansible 210, air glow 212, and the like. The workflow includes the hardware solution 114 which allows developers to start the installation by following a set of steps. Initially, a shipment is unwrapped. Typically, an installation or an update to the installation is packaged using partial compression or otherwise protected by encryption keys. Unwrapping refers to reversing the operations involving the encryption and the compression for content to be accessed without the knowledge of a packaging strategy. Further, the router 202 is connected and access to internet is configured. Furthermore, the computing system 100 is connected to the router 202 (if not integrated). Further, a set of edge nodes 214A, 214B, 214C, and 214D are connected to the router 202. The term set of edge nodes refers to a set of computers or a set of nodes installed at the customer site inside the internal zone. As used herein, the term ‘edge node’ is a computer that acts as an end user portal for communication with other nodes in cluster computing. For example, the edge node is a gateway node or edge communication node. Finally, an installation interface is opened. The term installation interface used herein refers to a user controlled, and operated tool thereby enabling end users to monitor and initiate the installation. The hardware solution 114 provides complete isolation from complexity of the network environment. The router 202 always gets the IP and access to the internet.

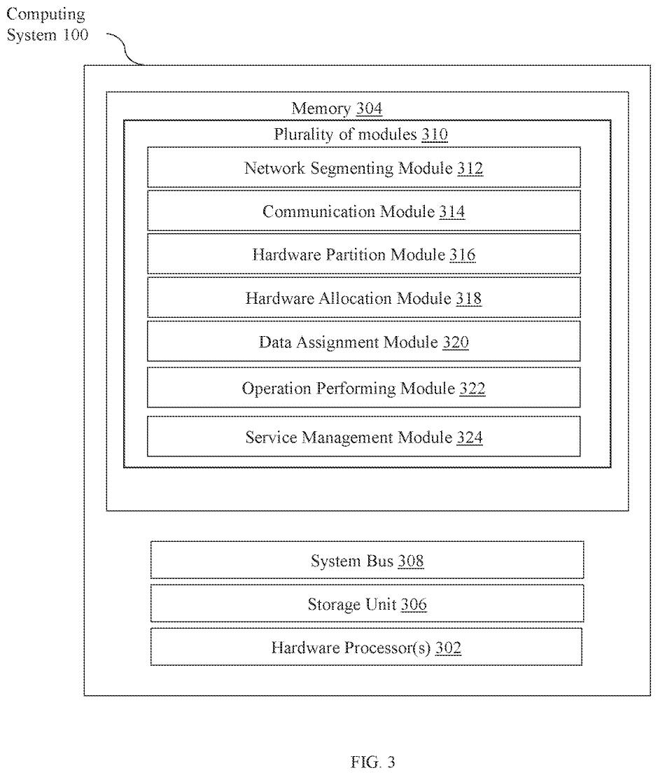

FIG. 3 is a block diagram illustrating an exemplary computing system 100 for managing and securing the enterprise network associated with an organization, in accordance with an embodiment of the present disclosure. Further, the computing system 100 includes one or more hardware processors 302, a memory 304 and a storage unit 306. The one or more hardware processors 302, the memory 304 and the storage unit 306 are communicatively coupled through a system bus 308 or any similar mechanism. The memory 304 comprises the plurality of modules 310 in the form of programmable instructions executable by the one or more hardware processors 302. Further, the plurality of modules 310 includes a network segmenting module 312, a communication module 314, a hardware partition module 316, a hardware allocation module 318, a data assignment module 320, an operation performing module 322, and a service management module 324.

The one or more hardware processors 302, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 302 may also include embedded controllers, such as generic or programmable logic devices or arrays, application specific integrated circuits, single-chip computers, and the like.

The memory 304 may be non-transitory volatile memory and non-volatile memory. The memory 304 may be coupled for communication with the one or more hardware processors 302, such as being a computer-readable storage medium. The one or more hardware processors 302 may execute machine-readable instructions and/or source code stored in the memory 304. A variety of machine-readable instructions may be stored in and accessed from the memory 304. The memory 304 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 304 includes the plurality of modules 310 stored in the form of machine-readable instructions on any of the above-mentioned storage media and may be in communication with and executed by the one or more hardware processors 302.

In an embodiment of the present disclosure, the storage unit 306 may be a local storage or cloud storage. The storage unit 306 may store the one or more access rights, the one or more internal services, a specific file directory, the one or more first permissions, the one or more second permissions and the like.

The network segmenting module 312 is configured to segment the enterprise network associated with an organization into the set of security zones. The enterprise network includes physical and virtual networks, and protocols that connect all users and systems on a Local Area Network (LAN) to applications in a data center and cloud as well as facilitates access to network data and analytics. In an embodiment of the present disclosure, the set of security zones include the external zone 102, the gateway zone 104 and the internal zone 106. In an embodiment of the present disclosure, the gateway zone 104 bridges the internal zone 106 and the external zone 102. The term external zone 102 used herein is a software with access to the external network, comprising of the internet. The term gateway zone 104 refers to a set of data and services that ensures directional access. In an exemplary embodiment of the present disclosure, the external zone 102 writes data to a specific location where the internal zone can read it from, on the contrary, the internal zone 106 writes to another location where the external zone 102 can read, however it is noted that the two locations are disjoint. The present invention uses separate folders in the file system. A gateway zone 104 that is controlled by other access paths can also be envisioned. For example, running a particular software that allows exclusive access to a particular interface to the external zone 102 and another disjoint interface to the internal zone 106.

The communication module 314 is configured to establish a communication path between the external zone 102 and an external network card 112 for allowing the external zone 102 to access a set of external networks. The term communication path used herein refers to a connection to the external network. Physically, a communication path is designated in a module with either WiFi or RJ45 ethernet connections. In an exemplary embodiment of the present disclosure, the external network may be internet. Further, the communication module 314 establishes a communication path between the internal zone 106 and an internal network card 116 for allowing the internal zone 106 to access the enterprise network upon establishing the communication path between the external zone 102 and the external network card 112.

The hardware partition module 316 is configured to perform a partitioning operation on a hardware solution 114 to divide the hardware partition into one or more hardware units upon establishing the communication path between the internal zone 106 and the internal network card 116. The term hardware partition refers to the configuration of the machine and the permissions set to the network cards and the storage areas. The present invention uses standard Linux operating system capabilities to manage the hardware partitions, which implies: Using Linux's disk partitioning to separate the data storage for each zone, setting up of separate user account for the various software modules, setting up user groups to control access, setting up group privileges to control access to disks or network cards. The present invention uses standard Unix often referred to POSIX access models for the hardware partition. In an embodiment of the present disclosure, the hardware solution 114 corresponds to a hard disk. In an exemplary embodiment of the present disclosure, the one or more hardware units include an external hardware unit, a gateway hardware unit and an internal hardware unit. In an embodiment of the present disclosure, two physical network cards or two separate computers are provided to ensure complete hardware separation for the direct connection to the networks. In the current scenario, a single computer is deployed with all the security zones implemented. For example, the single computer with two separate network cards is used. In an embodiment of the present disclosure, one network connection is explicitly marked to be used only for the external zone 102. Further, other network connection is explicitly marked to only be used for the internal zone 106.

The hardware allocation module 318 is configured to allocate the one or more hardware units to the set of security zones. In an embodiment of the present disclosure, the external hardware unit is allocated to the external zone 102, the gateway hardware unit is allocated to the gateway zone 104, and the internal hardware unit is allocated to the internal zone 106.

The data assignment module 320 is configured to assign one or more access rights to the external zone 102 for providing limited access of the allocated external hardware unit. In an exemplary embodiment of the present disclosure, the one or more access rights include read a specific directory in a file system, access to the external network card 112 and no access is provided to the internal network card 116, access to a set of specific external sites or a set of specific ports, limited to specific external protocols, write access to a specific directory, no read or delete access is provided to the specific directory, and the like. In an exemplary embodiment of the present disclosure access to the set of specific external sites or the set of specific general ports is controlled by the Transmission Control Protocol/Internet Protocol (TCP/IP) wherein, each of the set of servers is designated a particular address called IP address. Given an IP address, each of the set of servers can establish independent communication channels using sockets. The communication designation is a port. Each port has a particular number comprising of a 16-bit value. The set of specific external sites or a set of specific ports are designated to a protocol. For example, port 80 is for HTTP, port 443 is for HTTPS, port 22 for SSH, and the like. The present invention controls the possible connections that the services or software components are allowed to connect as well as control the incoming connections to the solution. Here are some examples of connections that the present invention allows: Fetching data from Google's Cloud Storage (GCS) using Google's proprietary tools such access requires the setup of permissions to access the ports for Google's services, publishing MQTT messages to Microsoft's Azure Event Hub requires that the external services allow connection to port 8883 or 443. Further, the data assignment module 320 is configured to assign one or more internal services to the internal zone 106 for performing one or more internal operations by using the allocated internal hardware unit upon assigning the one or more access rights to the external zone 102. In an exemplary embodiment of the present disclosure, the one or more internal services include install script runners, installation tools, PxE boot server, PxE boot image service, docker, workflow managers, offline repositories, data collection services, and the like. For example, the installation tools include ansible, dockerized version of multiple central installers, such as ansible, chef or puppet, saltstack, and the like. In an exemplary embodiment of the present disclosure, the PxE boot server may be fog server. In an embodiment of the present disclosure, the one or more internal operations performed by the docker include allowing a user to separate the set of security zones and isolate one or more modules. In an exemplary embodiment of the present disclosure, the one or more internal operations performed by the workflow managers include control of the installation, verification, testing workflow, and the like. For example, the workflow managers are airflow, Jenkins, and the like. In an embodiment of the present disclosure, the one or more internal operations performed by the offline repositories include local implementation of a set of repositories used in installation. For example, the offline repositories include Docker image repository, Python components, Node Package Manager (NPM) modules, Maven modules, Advanced Package Tool (APT) repository, and the like.

The operation performing module 322 is configured to perform one or more first gateway operations via the gateway zone 104 by using the allocated gateway hardware unit upon assigning the one or more internal services to the internal zone 106. In an exemplary embodiment of the present disclosure, the one or more first gateway operations include verification of certificates, verification of correctness of incoming and outgoing data, copying of data from the internal zone 106 to the external zone 102, and the like.

In an embodiment of the present disclosure, the operation module is configured to perform one or more second gateway operations on the gateway zone 104 by using one or more gateway agents upon launching a boot application. In an embodiment of the present disclosure, the boot application strictly controls the launch of every program and ensure that the correct permissions are being enforced. For example, the boot application launches the software for the gateway zone 104 first to perform the one or more second gateway operations on the gateway zone 104 by using the one or more gateway agents. In an exemplary embodiment of the present disclosure, the one or more second gateway operations include monitoring access, verifying integrity of a firmware, memory, and a storage before allowing services to run in the internal zone 106 and the external zone 102.

The service management module 324 is configured to start the one or more internal services in the internal zone 106 based on one or more first permissions upon running a boot application on the internal zone 106. For example, the boot application starts the services in the internal zone 106 with the one or more first permissions. The one or more first permissions vary with each internal service. In an exemplary embodiment of the present disclosure, the one or more first permissions include access to specific partitions or specific directories of a local storage, permission to open specific ports on the internal network card 116, permission to access specific ports opened in the gateway zone 104, and the like. Further, the service management module 324 is configured to start one or more external services in the external zone 102 based on one or more second permissions upon running the boot application on the external zone 102. For example, the boot application then starts up the external zone 102. As with the internal zone 106, the one or more second permissions for software running in the external zone 102 is limited to absolutely essential resources. In an exemplary embodiment of the present disclosure, the one or more second permissions include ability to open server ports on the external network card 112, permission to read, write or a combination thereof to specific partitions on an internal storage, permission to access specific ports opened in the gateway zone 104, and the like.

Further, a prohibition logic is implemented in the gateway zone 104 to manage services of each of the internal zone 106 and the external zone 102. In an exemplary embodiment of the present disclosure, the prohibition logic includes one or more modules running in the internal zone 106 and the external zone 102 are not allowed to access the same partitions or the directories, the one or more modules running in the internal zone 106 are not allowed to access the external network, the one or more modules running in the external zone 102 are not allowed to access the enterprise network, and the like.

In an embodiment of the present disclosure, the computing system 100 minimizes the access to the external networks to certified software modules that have no access to the internal network (but access to shared storage). Furthermore, the computing system 100 minimizes the access to the shared storage to certified software modules that can distribute the modules/data to the internal network. In an embodiment of the present disclosure, in extreme cases where no access is possible, the computing system 100 may allow local upload of configuration/images using more primitive methods, such as Universal Serial Bus (USB) devices. The computing system 100 manages offline software repositories by securely downloading the software modules and run multiple independent verification tests of the downloaded software. The computing system 100 runs all centrally controlled installations. For example, installation scripts, such as Ansible, Chef/Puppet, Terraform, and the like, that are orchestrated from a central need a runner. The computing system 100 also provide limited data transfer to external networks by controlling the upload (including preventing upload) to limited hosts/ports/Virtual Private Networks (VPN's) according to rules controlled by the computing system 100.

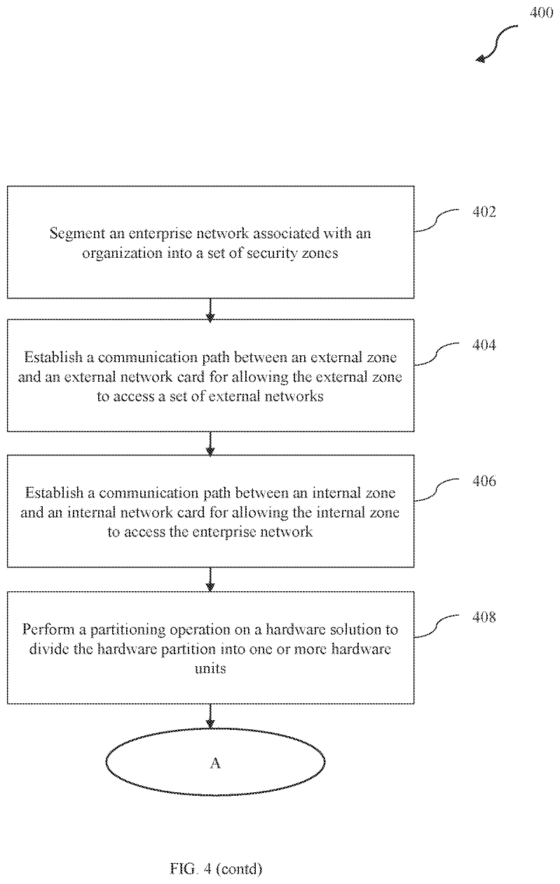

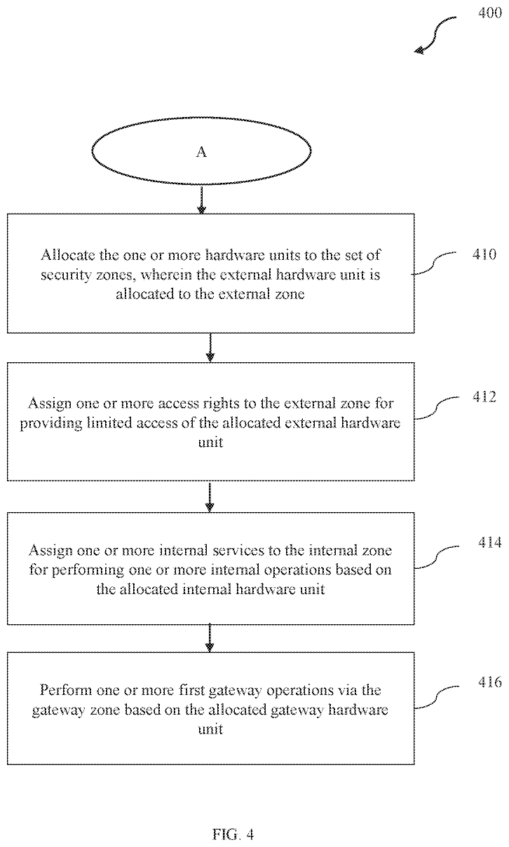

FIG. 4 is a process flow diagram illustrating an exemplary method managing and securing an enterprise network associated with an organization, in accordance with an embodiment of the present disclosure. At step 402, the enterprise network associated with an organization is segmented into a set of security zones. The enterprise network includes physical and virtual networks, and protocols that connect all users and systems on a LAN to applications in a data center and cloud as well as facilitates access to network data and analytics. In an embodiment of the present disclosure, the set of security zones include the external zone 102, the gateway zone 104 and the internal zone 106. In an embodiment of the present disclosure, the gateway zone 104 bridges the internal zone 106 and the external zone 102.

At step 404, a communication path is established between the external zone 102 and an external network card 112 for allowing the external zone 102 to access a set of external networks. In an exemplary embodiment of the present disclosure, the external network may be internet.

At step 406, a communication path is established between the internal zone 106 and an internal network card 116 for allowing the internal zone 106 to access the enterprise network upon establishing the communication path between the external zone 102 and the external network card 112.

At step 408, a partitioning operation is performed on a hardware solution 114 to divide the hardware partition into one or more hardware units upon establishing the communication path between the internal zone 106 and the internal network card 116. In an embodiment of the present disclosure, the hardware solution 114 corresponds to a hard disk. In an exemplary embodiment of the present disclosure, the one or more hardware units include an external hardware unit, a gateway hardware unit and an internal hardware unit. In an embodiment of the present disclosure, two physical network cards or two separate computers are provided to ensure complete hardware separation for the direct connection to the networks. In the current scenario, a single computer is deployed with all the security zones implemented. For example, the single computer with two separate network cards is used. In an embodiment of the present disclosure, one network connection is explicitly marked to be used only for the external zone 102. Further, other network connection is explicitly marked to only be used for the internal zone 106.

At step 410, the one or more hardware units are allocated to the set of security zones. In an embodiment of the present disclosure, the external hardware unit is allocated to the external zone 102, the gateway hardware unit is allocated to the gateway zone 104, and the internal hardware unit is allocated to the internal zone 106.

At step 412, one or more access rights are assigned to the external zone 102 for providing limited access of the allocated external hardware unit. In an exemplary embodiment of the present disclosure, the one or more access rights include read a specific directory in a file system, access to the external network card 112 and no access is provided to the internal network card 116, access to a set of specific external sites or a set of specific ports, limited to specific external protocols, write access to a specific directory, no read or delete access is provided to the specific directory, and the like.

At step 414, one or more internal services are assigned to the internal zone 106 for performing one or more internal operations by using the allocated internal hardware unit upon assigning the one or more access rights to the external zone 102. In an exemplary embodiment of the present disclosure, the one or more internal services include install script runners, installation tools, PxE boot server, PxE boot image service, docker, workflow managers, offline repositories, data collection services, and the like. For example, the installation tools include ansible, dockerized version of multiple central installers, such as ansible, chef or puppet, saltstack, and the like. In an exemplary embodiment of the present disclosure, the PxE boot server may be fog server. In an embodiment of the present disclosure, the one or more internal operations performed by the docker include allowing a user to separate the set of security zones and isolate one or more modules. In an exemplary embodiment of the present disclosure, the one or more internal operations performed by the workflow managers include control of the installation, verification, testing workflow, and the like. For example, the workflow managers are airflow, Jenkins, and the like. In an embodiment of the present disclosure, the one or more internal operations performed by the offline repositories include local implementation of a set of repositories used in installation. For example, the offline repositories include Docker image repository, Python components, Node Package Manager (NPM) modules, Maven modules, Advanced Package Tool (APT) repository, and the like.

At step 416, one or more first gateway operations are performed via the gateway zone 104 by using the allocated gateway hardware unit upon assigning the one or more internal services to the internal zone 106. In an exemplary embodiment of the present disclosure, the one or more first gateway operations include verification of certificates, verification of correctness of incoming and outgoing data, copying of data from the internal zone 106 to the external zone 102, and the like.

In an embodiment of the present disclosure, the method 400 includes performing one or more second gateway operations on the gateway zone 104 by using one or more gateway agents upon launching a boot application. In an embodiment of the present disclosure, the boot application strictly controls the launch of every program and ensure that the correct permissions are being enforced. For example, the boot application launches the software for the gateway zone 104 first to perform the one or more second gateway operations on the gateway zone 104 by using the one or more gateway agents. In an exemplary embodiment of the present disclosure, the one or more second gateway operations include monitoring access, verifying integrity of a firmware, memory, and a storage before allowing services to run in the internal zone 106 and the external zone 102.

The method 400 includes starting the one or more internal services in the internal zone 106 based on one or more first permissions upon running a boot application on the internal zone 106. For example, the boot application starts the services in the internal zone 106 with the one or more first permissions. The one or more first permissions vary with each internal service. In an exemplary embodiment of the present disclosure, the one or more first permissions include access to specific partitions or specific directories of a local storage, permission to open specific ports on the internal network card 116, permission to access specific ports opened in the gateway zone 104, and the like. Further, the method 400 includes starting one or more external services in the external zone 102 based on one or more second permissions upon running the boot application on the external zone 102. For example, the boot application then starts up the external zone 102. As with the internal zone 106, the one or more second permissions for software running in the external zone 102 is limited to absolutely essential resources. In an exemplary embodiment of the present disclosure, the one or more second permissions include ability to open server ports on the external network card 112, permission to read, write or a combination thereof to specific partitions on an internal storage, permission to access specific ports opened in the gateway zone 104, and the like.

In an embodiment of the present disclosure, a prohibition logic is implemented in the gateway zone 104 to manage services of each of the internal zone 106 and the external zone 102. In an exemplary embodiment of the present disclosure, the prohibition logic includes one or more modules running in the internal zone 106 and the external zone 102 are not allowed to access the same partitions or the directories, the one or more modules running in the internal zone 106 are not allowed to access the external network, the one or more modules running in the external zone 102 are not allowed to access the enterprise network, and the like.

The AI-based method 400 may be implemented in any suitable hardware, software, firmware, or combination thereof.

Thus, various embodiments of the present system provide a solution to manage and secure an enterprise network associated with an organization. The computing system 100 facilitates isolation of external and internal networks when installing edge compute solutions. Further, the computing system 100 supports local installation of compute nodes in environments where the network has to be isolated from external networks, such as the internet. Since the enterprise network is not exposed to external networks, the enterprise network is secure from external threats, such as malware attacks, ransomware attacks, and the like. In an embodiment of the present disclosure, the computing system 100 isolates the external networks from the internal networks to enable limited or no access to public networks. Further, the computing system 100 provides two physical network cards (or in some cases two separate computers) to ensure complete hardware separation for the direct connection to the networks. The computing system 100 minimizes the access to the external networks to certified software modules that have no access to the internal network (but access to shared storage). Furthermore, the computing system 100 minimizes the access to the shared storage to certified software modules that can distribute the modules/data to the internal network. In an embodiment of the present disclosure, in extreme cases where no access is possible, the computing system 100 may allow local upload of configuration/images using more primitive methods, such as Universal Serial Bus (USB) devices. The computing system 100 manages offline software repositories by securely downloading the software modules and run multiple independent verification tests of the downloaded software. The computing system 100 runs all centrally controlled installations. For example, installation scripts, such as Ansible, Chef/Puppet, Terraform, and the like, that are orchestrated from a central need a runner. The computing system 100 also provide limited data transfer to external networks by controlling the upload (including preventing upload) to limited hosts/ports/Virtual Private Networks (VPN's) according to rules controlled by the computing system 100. The computing system 100 discloses a specific configuration to be used by developers to minimize the complexity of installation of complex solutions. For example, the complexity is reduced for the developers to get started and simplify the work of setting up a compute cluster.

In an exemplary embodiment of the present disclosure some of the technologies that are used in the present invention and require frequent interaction with online repositories are Software modules deployed through docker containers. Examples of such components are: Open source, Eclipse Mosquitto, Filebeat, Node-Red, closed sourced, customer-specific solutions running on edge computers, Pratexo Event Recorder, Software modules deployed via Docker in Kubernetes Helm Charts, Open source, Apache Kafka, Elasticsearch, MongoDB, Apache Spark, Closed source, Customer solutions, Pratexo Expert System, Pratexo Node Configuration Manager, Fundamental software modules natively installed on the edge computers, Operating system patches, Kernel updates, Library updates, Tools, Interpreters (e.g., Python, Ruby), Compilers (e.g., C++, NodeJS) and the like.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.)

can be coupled to the system either directly or through intervening I/O. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus 308 to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

We claim:

1. A computing system for managing and securing an enterprise network associated with an organization, the computing system comprising:
one or more hardware processors; and
a memory coupled to the one or more hardware processors, wherein the memory comprises a plurality of modules in the form of programmable instructions executable by the one or more hardware processors, and wherein the plurality of modules comprises:
a network segmenting module configured to segment an enterprise network associated with an organization into a set of security zones, wherein the set of security zones comprise an external zone, a gateway zone and an internal zone, and wherein the gateway zone bridges the internal zone and the external zone;
a communication module configured to:
establish a communication path between the external zone and an external network card for allowing the external zone to access a set of external networks; and
establish a communication path between the internal zone and an internal network card for allowing the internal zone to access the enterprise network upon establishing the communication path between the external zone and the external network card;
a hardware partition module configured to perform a partitioning operation on a hardware solution to divide the hardware partition into one or more hardware units upon establishing the communication path between the internal zone and the internal network card, wherein the hardware solution corresponds to a hard disk, and wherein the one or more hardware units comprise an external hardware unit, a gateway hardware unit and an internal hardware unit;
a hardware allocation module configured to allocate the one or more hardware units to the set of security zones, wherein the external hardware unit is allocated to the external zone, wherein the gateway hardware unit is allocated to the gateway zone, and wherein the internal hardware unit is allocated to the internal zone;
a data assignment module configured to:
assign one or more access rights to the external zone for providing limited access of the allocated external hardware unit; and
assign one or more internal services to the internal zone for performing one or more internal operations by using the allocated internal hardware unit upon assigning the one or more access rights to the external zone, wherein the one or more internal services comprise install script runners, installation tools, PxE boot server, PxE boot image service, docker, workflow managers, offline repositories and data collection services; and
an operation performing module configured to perform one or more first gateway operations via the gateway zone by using the allocated gateway hardware unit upon assigning the one or more internal services to the internal zone, wherein the one or more first gateway operations comprise verification of certificates, verification of correctness of incoming and outgoing data, and copying of data from the internal zone to the external zone.

2. The computing system of claim 1, wherein the one or more access rights comprise read a specific directory in a file system, access to the external network card, access to one of: a set of specific external sites and a set of specific ports, limited to specific external protocols, and write access to a specific directory.

3. The computing system of claim 1, wherein the operation module is configured to perform one or more second gateway operations on the gateway zone by using one or more gateway agents upon launching a boot application, and wherein the one or more second gateway operations comprise monitoring access, verifying integrity of a firmware, memory, and a storage before allowing services to run in the internal zone and the external zone.

4. The computing system of claim 1, further comprising a service management module configured to start the one or more internal services in the internal zone based on one or more first permissions upon running a boot application on the internal zone.

5. The computing system of claim 4, wherein the one or more first permissions comprise access to one of: specific partitions and specific directories of a local storage, permission to open specific ports on the internal network card, and permission to access specific ports opened in the gateway zone.

6. The computing system of claim 4, wherein the service management module configured to start one or more external services in the external zone based on one or more second permissions upon running the boot application on the external zone.

7. The computing system of claim 6, wherein the one or more second permissions comprise ability to open server ports on the external network card, permission to at least one of: read and write to specific partitions on an internal storage, and permission to access specific ports opened in the gateway zone.

8. The computing system of claim 1, wherein a prohibition logic is implemented in the gateway zone to manage services of each of the internal zone and the external zone, and wherein the prohibition logic comprises one or more modules running in the internal zone and the external zone are not allowed to access the one of: same partitions and directories, the one or more modules running in the internal zone are not allowed to access the external network and the one or more modules running in the external zone are not allowed to access the enterprise network.

9. The computing system of claim 1, wherein the one or more internal operations performed by the docker comprise allowing a user to separate the set of security zones and isolate one or more modules, wherein the one or more internal operations performed by the workflow managers comprise control of the installation, verification and testing workflow, and wherein the one or more internal operations performed by the offline repositories comprise local implementation of a set of repositories used in installation.

10. A method for managing and securing an enterprise network associated with an organization, the method comprising:
segmenting, by one or more hardware processors, an enterprise network associated with an organization into a set of security zones, wherein the set of security zones comprise an external zone, a gateway zone and an internal zone, and wherein the gateway zone bridges the internal zone and the external zone;
establishing, by the one or more hardware processors, a communication path between the external zone and an external network card for allowing the external zone to access a set of external networks;
establishing, by the one or more hardware processors, a communication path between the internal zone and an internal network card for allowing the internal zone to access the enterprise network upon establishing the communication path between the external zone and the external network card;
performing, by the one or more hardware processors, a partitioning operation on a hardware solution to divide the hardware partition into one or more hardware units upon establishing the communication path between the internal zone and the internal network card, wherein the hardware solution corresponds to a hard disk, and wherein the one or more hardware units comprise an external hardware unit, a gateway hardware unit and an internal hardware unit;
allocating, by the one or more hardware processors, the one or more hardware units to the set of security zones, wherein the external hardware unit is allocated to the external zone, wherein the gateway hardware unit is allocated to the gateway zone, and wherein the internal hardware unit is allocated to the internal zone;
assigning, by the one or more hardware processors, one or more access rights to the external zone for providing limited access of the allocated external hardware unit;
assigning, by the one or more hardware processors, one or more internal services to the internal zone for performing one or more internal operations by using the allocated internal hardware unit upon assigning the one or more access rights to the external zone, wherein the one or more internal services comprise install script runners, installation tools, PxE boot server, PxE boot image service, docker, workflow managers, offline repositories and data collection services; and
performing, by the one or more hardware processors, one or more first gateway operations via the gateway zone by using the allocated gateway hardware unit upon assigning the one or more internal services to the internal zone, wherein the one or more first gateway operations comprise verification of certificates, verification of correctness of incoming and outgoing data, and copying of data from the internal zone to the external zone.

11. The method of claim 10, wherein the one or more access rights comprise read a specific directory in a file system, access to the external network card, access to one of: a set of specific external sites and a set of specific ports, limited to specific external protocols, and write access to a specific directory.

12. The method of claim 10, further comprising performing one or more second gateway operations on the gateway zone by using one or more gateway agents upon launching a boot application, and wherein the one or more second gateway operations comprise monitoring access, verifying integrity of a firmware, memory, and a storage before allowing services to run in the internal zone and the external zone.

13. The method of claim 10, further comprising starting the one or more internal services in the internal zone based on one or more first permissions upon running a boot application on the internal zone.

14. The method of claim 13, wherein the one or more first permissions comprise access to one of: specific partitions and specific directories of a local storage, permission to open specific ports on the internal network card, and permission to access specific ports opened in the gateway zone.

15. The method of claim 13, further comprising starting one or more external services in the external zone based on one or more second permissions upon running the boot application on the external zone.

16. The method of claim 15, wherein the one or more second permissions comprise ability to open server ports on the external network card, permission to at least one of: read and write to specific partitions on an internal storage, and permission to access specific ports opened in the gateway zone.

17. The method of claim 10, wherein a prohibition logic is implemented in the gateway zone to manage services of each of the internal zone and the external zone, and wherein the prohibition logic comprises one or more modules running in the internal zone and the external zone are not allowed to access the one of: same partitions and directories, the one or more modules running in the internal zone are not allowed to access the external network and the one or more modules running in the external zone are not allowed to access the enterprise network.

18. The method of claim 10, wherein the one or more internal operations performed by the docker comprise allowing a user to separate the set of security zones and isolate one or more modules, wherein the one or more internal operations performed by the workflow managers comprise control of the installation, verification and testing workflow, and wherein the one or more internal operations performed by the offline repositories comprise local implementation of a set of repositories used in installation.

19. A non-transitory computer-readable storage medium having instructions stored therein that, when executed by a hardware processor, cause the processor to perform method steps comprising:
segmenting an enterprise network associated with an organization into a set of security zones, wherein the set of security zones comprise an external zone, a gateway zone and an internal zone, and wherein the gateway zone bridges the internal zone and the external zone;
establishing a communication path between the external zone and an external network card for allowing the external zone to access a set of external networks;
establishing a communication path between the internal zone and an internal network card for allowing the internal zone to access the enterprise network upon establishing the communication path between the external zone and the external network card;
performing a partitioning operation on a hardware solution to divide the hardware partition into one or more hardware units upon establishing the communication path between the internal zone and the internal network card, wherein the hardware solution corresponds to a hard disk, and wherein the one or more hardware units comprise an external hardware unit, a gateway hardware unit and an internal hardware unit;
allocating the one or more hardware units to the set of security zones, wherein the external hardware unit is allocated to the external zone, wherein the gateway hardware unit is allocated to the gateway zone, and wherein the internal hardware unit is allocated to the internal zone;
assigning one or more access rights to the external zone for providing limited access of the allocated external hardware unit;
assigning one or more internal services to the internal zone for performing one or more internal operations by using the allocated internal hardware unit upon assigning the one or more access rights to the external zone, wherein the one or more internal services comprise install script runners, installation tools, PxE boot server, PxE boot image service, docker, workflow managers, offline repositories and data collection services; and
performing one or more first gateway operations via the gateway zone by using the allocated gateway hardware unit upon assigning the one or more internal services to the internal zone, wherein the one or more first gateway operations comprise verification of certificates, verification of correctness of incoming and outgoing data, and copying of data from the internal zone to the external zone.

20. The non-transitory computer-readable storage medium of claim 19, wherein the one or more access rights comprise read a specific directory in a file system, access to the external network card, access to one of: a set of specific external sites and a set of specific ports, limited to specific external protocols, and write access to a specific directory.
